(19) United States
(12) Patent Application Publication
(10) Pub. No.: US 2007/0146244 A1
(43) Pub. Date: Jun. 28, 2007

(54) Display device

(75) Inventors: Akio Fukushima, Tokyo (JP); Hiroshi Toriumi, Tokyo (JP); Fumiko Kikuchi, Tokyo (JP); Naoko Ito, Tokyo (JP); Koji Suzuki, Tokyo (JP); Takayuki Kasuya, Tokyo (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/443,476

(22) Filed: May 31, 2006

(30) Foreign Application Priority Data
Dec. 26, 2005 (JP) 2005-372646

(51) Int. Cl. G09G 3/30

(52) U.S. Cl. 345/76

(57) ABSTRACT

A display device that displays an image on a display screen includes plural light emitting members arranged along the display screen. The light emitting members emit light along a longitudinal direction thereof, and are coupled so that the light emitting members can be rolled around center of axis parallel to the longitudinal direction. The rolled light emitting members are stored in a storage unit such that one side of the display screen is supported by a support member provided in the storage unit.

### BACKGROUND OF THE INVENTION

1. Field of the Invention

The present invention relates to a display device, and more particularly to a display device having a large screen.

2. Description of the Related Art

Conventionally, large-screen display devices using various types of display methods, such as a plasma display panel (PDP) method, a liquid crystal method, and a rear projection method, are developed. In recent years, a display device larger than a display device of 60 inches, which is currently in practical use, is demanded. A conventional display device is generally placed at the same place at any time, regardless of whether the display device is being used or unused. However, if a display device having a large screen (for example, 100 inches or larger) is placed even while the display device is not used, an effective use of a limited space cannot be achieved.

A display method using a roll screen and a projector that projects an image on the screen is conventionally used. With this method, it is possible to enjoy images on a large screen while storing the screen when it is not used, by rolling up the screen. However, the screen and the projector are provided and handled separately, which causes a trouble to users.

Japanese Patent Laid-Open No. 2002-538502 discloses a technique in which a plurality of fibers are arranged in parallel for regulating a display screen of a display device. The respective fibers in the display device include a plurality of light emitting diodes arranged in a lengthwise direction, and each diode includes two electrodes.

The display device supplies an electric signal to between the two electrodes included in the fiber, to make the light emitting diodes emit light, thereby displaying pixels and sub-pixels of an image and information. Each fiber includes electrical conductors accumulated in the lengthwise direction and serving as first electrodes, a light emitting layer accumulated thereon, and a plurality of electrical contacts accumulated on a light emitting material and serving as second electrodes of the light emitting diodes.

In the technique, the display device can be made compact while the display device is not used, by rolling up the display device around the center of axis parallel to the lengthwise direction of the fibers. However, the configuration of the device becomes complicated since the light emitting diodes are required as much as the number of pixels, thereby increasing the weight of the display device. Therefore, even if the display device is downsized, handling of the display device is difficult.

### SUMMARY OF THE INVENTION

It is an object of the present invention to at least solve the above problems in the present invention.

A display device according to one aspect of the present invention displays an image on a display screen. The display device includes a plurality of light emitting members configured to emit light along a longitudinal direction thereof and arranged along the display screen. The light emitting members are coupled to each other so that the light emitting members on the display screen are rolled around center of axis substantially parallel to the longitudinal direction.

A display device according to another aspect of the present invention displays an image on a display screen. The display device includes a plurality of light emitting members configured to emit light along a longitudinal direction thereof, and arranged along the display screen. The light emitting members are arranged so that the light emitting members are rolled around center of axis not parallel to the longitudinal direction.

A display device according to still another aspect of the present invention displays an image, and includes a display screen including a plurality of optical fibers each which has a light emitting device on one of edges thereof, that the optical fibers arranged on a flexible sheet in a first direction, and a plurality of optical shutters configured to intercept light emitted from the optical fibers and that are arranged on the optical fibers in a second direction; and a control unit configured to control display of the image on the display screen, and to control the light emitting devices and the optical shutters based on image data.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a display device according to a first embodiment of the present invention;

FIG. 2 is a schematic for illustrating a principle of display by the display device;

FIG. 3 is a schematic for illustrating a principle of display by the display device;

FIG. 4 is a schematic for illustrating a display operation in the display device;

FIG. 5 is a schematic of the display device having another configuration;

FIG. 6 is a schematic of a display device according to a second embodiment of the present invention;

FIG. 7 is a plan view of a display device of an example;

FIG. 8 is a schematic of a display screen;

FIG. 9 is a perspective view of a light emitting tube;

FIG. 10 is a cross-section of another light emitting tube;

FIG. 11 is a block diagram of the display device;

FIG. 12 is a schematic for illustrating a display operation in the display device; and

FIG. 13 is a schematic of a display device of another example.

### DETAILED DESCRIPTION OF THE PREFERRED EMBODIMENTS

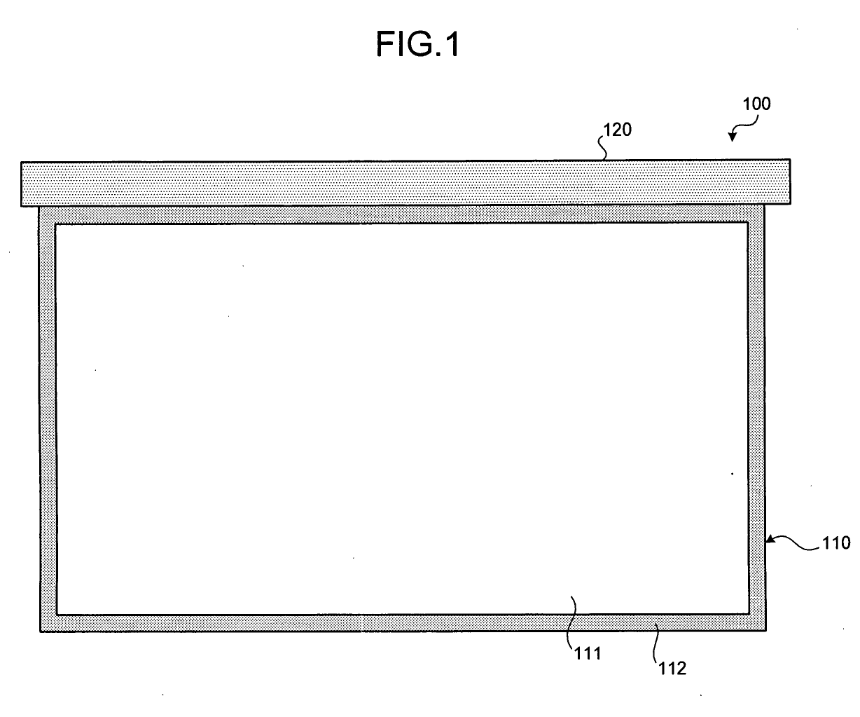

Exemplary embodiments according to the present invention will be explained in detail below with reference to the accompanying drawings. FIG. 1 is a schematic of a display device according to a first embodiment of the present invention. A display device 100 includes a display unit 110 and a storage unit 120, as parts that can be confirmed externally.

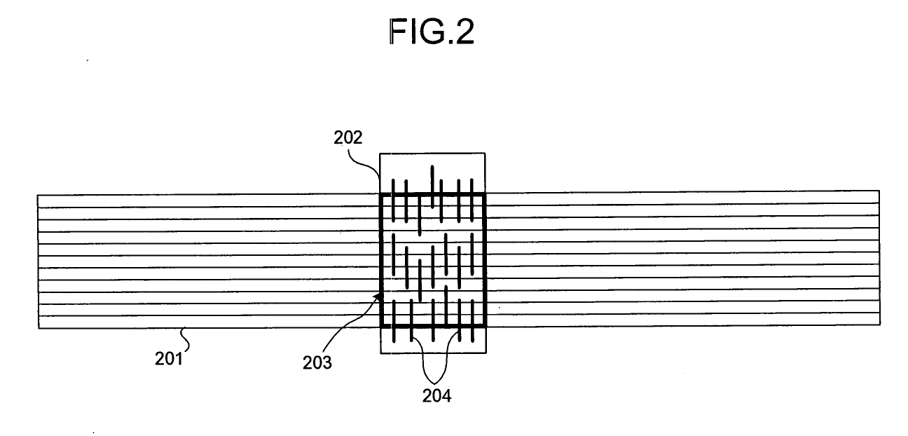

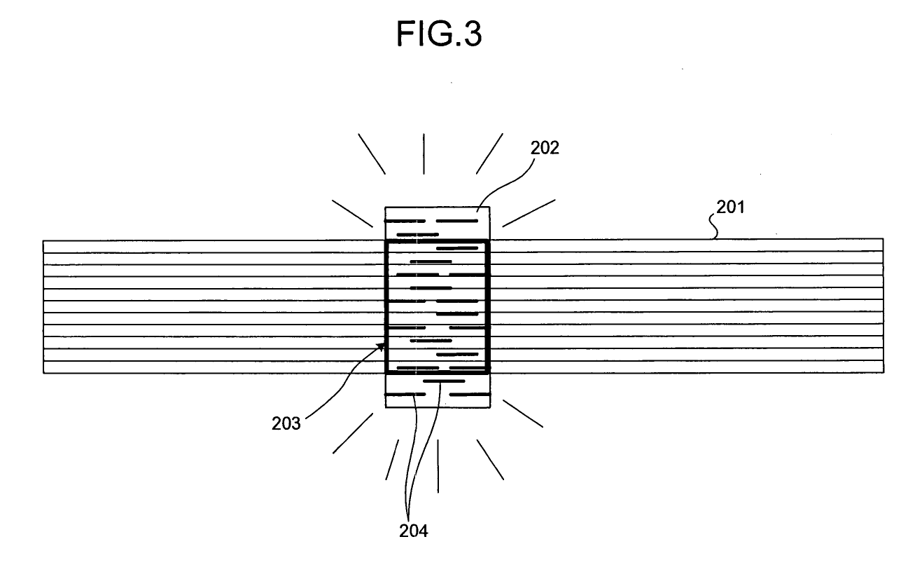

The display unit 110 includes a display screen 111 having a flat surface for displaying images, and a display frame 112 provided on, for example, four sides of the display screen 111. The display screen includes a plurality of light emitting members (see FIGS. 2 and 3) having a longitudinal shape extending in one direction. Each of the light emitting members emits light along the longitudinal direction. The light emitting members are provided such that the longitudinal directions thereof are made parallel to a scanning direction on the display screen.

The light emitting member may be configured to emit light by itself, or to emit light by propagating light emitted by an external member. In the former case, the light emitting member can be realized, for example, with a fluorescent tube, or with a base material on which a film of an organic electroluminescence (EL) material is formed. In the latter case, the light emitting member can be realized, for example, with an optical fiber or with a light diffusing member formed by mixing a light diffusing material to resin into a cylindrical shape. Furthermore, the light emitting member may be realized with a material having flexibility.

Plural pixel units are provided in each of the light emitting members along the longitudinal direction thereof (see FIGS. 2 and 3). The pixel units are arranged in a matrix on the display screen side, and transmit light emitted from the light emitting members toward the display screen. Specifically, the pixel units can be realized by liquid crystal elements that shield or transmit light corresponding to application of a voltage. The liquid crystal elements are arranged along the longitudinal direction of the respective light emitting members, and the electrode is provided for each liquid crystal element.

A pixel unit to emit light is selected, for example, based on image data for displaying images on the display screen, by a light emission controller (not shown). The light emission controller controls the respective pixel units so that the pixel units to emit light are sequentially changed along the longitudinal direction of the light emitting member.

For example, when the pixel units are realized by the liquid crystal elements, the light emission controller makes the light emitting member emit light based on the image data, and selects an electrode to which the voltage is not applied, so that the voltage in the selected electrode becomes a non-applied state. As a result, an orientation of liquid crystal molecules between the electrodes, to which the voltage is not applied, is changed, and the light emitted from the light emitting members is radiated toward the display screen in the selected pixel unit, thus, the pixel unit emits light.

The light emitting members can emit only the light polarized in a specific direction. Specifically, a liquid crystal material, or a polarizing plate, in which the orientation of the liquid crystal molecules are arranged in a predetermined direction is provided on the outer circumference of the light emitting member. Consequently, the light emitting member can emit only the light polarized in a specific direction to the pixel units.

When the light emitting members that emit light by propagating the light emitted externally instead of emitting light by itself are used, a light source that enters light to the light emitting member needs to be provided. In this case, the light source is provided at one end of the light emitting member in the longitudinal direction thereof. Specifically, for example, a light emitting diode (LED), and a light bulb can be used as the light source. The quantity of light emitted from the light source can be variable. For example, a light source of which luminous amount changes corresponding to the supplied electric energy can be used.

The light source may be provided such that a single light source uniformly inputs light into a plurality of light guiding members. The light source may be provided in plurality so as to provide the light source to each light emitting member. When a plurality of light sources are provided, each light source can emit light of a plurality of colors including red, blue, and green for each light emitting member, or can emit red, blue, or green light for each light emitting member.

In the display screen 111, the light emitting members are coupled so as to be rolled around the center of axis parallel to the longitudinal direction of the light emitting members. Specifically, the light emitting members are coupled to each other like a bamboo blind by using a coupling member formed of a flexible material, and by bending the coupling member, the light emitting members can be rolled around the center of axis substantially parallel to the longitudinal direction of the light emitting members.

For example, the light emitting members are fixed to a retractable sheet member, and the light emitting members can be rolled around the center of axis substantially parallel to the longitudinal direction of the light emitting members by rolling up the sheet member. In this case, by forming the sheet member from a material having optical transparency, the sheet member can be provided on the display screen side with respect to the light emitting members. By providing the sheet member on the display screen side than the light emitting members, the light emitting members can be protected from foreign matters such as dust, by the sheet member and the display frame 112.

The light emitting members are realized with the organic EL material, by forming the organic EL material into a sheet by printing or the like. By rolling up the sheet thus formed, the light emitting members can be rolled around the center of axis substantially parallel to the longitudinal direction of the light emitting members. In this case, the sheet member can be rolled in a plurality of directions corresponding to the flexibility of the sheet member and the organic EL material, other than the direction around the center of axis substantially parallel to the longitudinal direction of the light emitting members.

The storage unit 120 includes a storage space for storing the display screen 111 in a rolled state. In the storage space, the light emitting members are stored in a state rolled around the center of axis parallel to the longitudinal direction of the light emitting members. A support member (not shown) that supports one end of the display screen 111 is provided in the storage space.

Specifically, the support member can be realized, for example, with a shaft member that supports one end of the display frame 112. The display screen 111 can be stored in the storage space while it is rolled around the support member. The light emission controller is stored in the storage unit 120.

In a state where the light emitting members are stored in the storage space, the light sources are stored in the storage space together with the light emitting members. For example, if a single light source is used, the light source provided at the end of the light emitting member in the longitudinal direction can be rolled together with the light emitting member, for example, by using an organic EL panel formed of a retractable material as the light source.

FIGS. 2 and 3 are schematics for illustrating a principle of the display device 100 according to the first embodiment. Reference numeral 201 denotes the light emitting member. Liquid crystal materials controlled so as to be oriented along the longitudinal direction of the light emitting members 201 are provided on the outer circumference of the light emitting members 201. Accordingly, only the light polarized in a specific direction having passed through the liquid crystal materials is emitted from the light emitting members 201.

Reference numeral 202 denotes a liquid crystal element. Although not shown, a plurality of liquid crystal elements are arranged along the longitudinal direction of the light emitting members 201, and an electrode pair for applying a voltage to the respective liquid crystal elements 202 is provided for each liquid crystal element 202. In FIGS. 2 and 3, reference numeral 203 denotes the pixel unit. The pixel unit 203 is an area where the light emitting members 201 and the liquid crystal element 202 cross each other, and there are the pixel units 203 as many as the number of the liquid crystal elements 202.

FIG. 2 illustrates a state where a voltage is applied to the liquid crystal elements 202. Liquid crystal molecules 204 in the liquid crystal element 202 are oriented to a different direction from the polarization direction of the light emitted from the light emitting members 201. Accordingly, the pixel units 203 are in a dark state, regardless of whether the light emitting members 201 are emitting light.

FIG. 3 illustrates a state where the voltage is not applied to the liquid crystal element 202. The liquid crystal molecules 204 in the liquid crystal element 202 are oriented in the same direction as the polarization direction of the light emitted from the light emitting members 201. Therefore, when the light emitting members 201 emit light, since the light emitted from the light emitting members 201 passes through the pixel units 203, the pixel units 203 become bright.

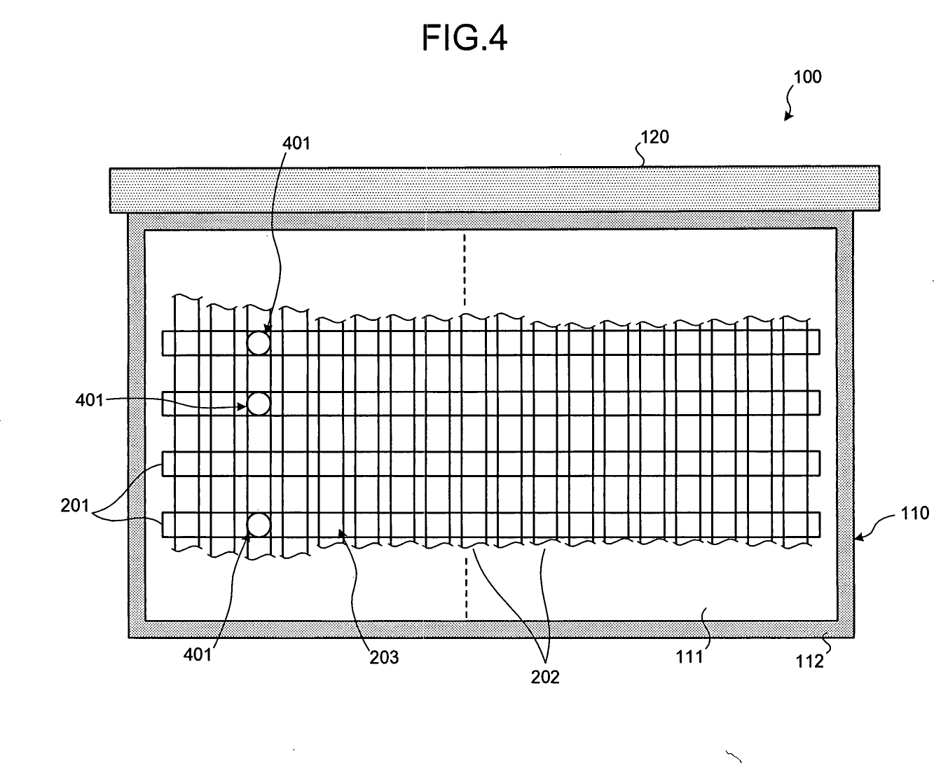

FIG. 4 is a schematic for illustrating a display operation of the display device 100. The liquid crystal elements 202 have a long shape arranged continuously along the arrangement direction of the light emitting members 201. As a result, the voltage-applied state with respect to the liquid crystal element 202, that is, the orientation of the liquid crystal molecules in the liquid crystal element 202 becomes uniform along the arrangement direction of the light emitting members 201.

The liquid crystal element 202 is generally formed with a material having low flexibility such as glass. However, the material thereof is not limited to glass, as long as the material has optical transparency required for the display device 100. The liquid crystal element 202 can be formed of a flexible material such as a polymer material, instead of glass. Accordingly, the individual liquid crystal element 202 has flexibility. Particularly, when the display device 100 having the configuration as shown in FIG. 4 is used, it is preferable that the liquid crystal elements 202 have the flexibility.

In the display device 100 shown in FIG. 4, a portion where the light emitting member 201 and the liquid crystal element 202 cross each other becomes the pixel unit 203. The light emission controller in the display device 100 makes the light emitting members 201 including the pixel unit 203 that should emit light, emit light based on the image data at the time of display operation, and sets the application state of the voltage in the electrode of the liquid crystal element 202 including the pixel unit 401 that should emit light to a non-applied state selectively.

For example, if the light emitting member 201 emits light spontaneously, the light emission controller controls light emission/non-emission timing of the light emitting member 201 including a pixel unit 401 that should emit light, and voltage application/non-application timing in the electrode of the liquid crystal element 202 including the pixel unit 401 that should emit light. On the other hand, if the light emitting member 201 emits light by propagating the light emitted from the light source, the light emission controller controls turning on/off timing of the light source corresponding to the light emitting member 201 including the pixel unit 401 that should emit light, and voltage application/non-application timing in the electrode of the liquid crystal element 202 including the pixel unit 401 that should emit light.

If a single light source is used, the light emission controller controls only the turning on/off timing of the light source. On the other hand, if there are plural light sources, the light emission controller controls the turning on/off timing of the relevant light source based on the image data. Accordingly, the relevant light emitting member 201 emits light, synchronized with the turning on/off timing of the light source.

If the light sources respectively emit light of a plurality of colors including red, blue, and green for each of the light emitting members 201, the light emission controller controls the turning on/off timing of the light sources that emit the relevant color based on the image data. Accordingly, the respective light emitting members 201 emit light of the corresponding color, respectively.

If the light sources respectively emit red, blue, or green light for each of the light emitting members 201, the light emission controller controls the turning on/off timing of the relevant light source based on the image data. Accordingly, the relevant light emitting members 201 respectively emit light in a color emitted from the light source.

Thus, since the light emission controller controls the turning on/off timing of the light sources based on the image data, and the voltage application/non-application timing in the electrode of the corresponding liquid crystal element 202 based on the image data, the pixel unit 203 formed of the liquid crystal element 202, in which the voltage is not applied, emits light in a color emitted from the light emitting member 201.

Furthermore, the light emission controller makes the pixel units 203 that should emit light sequentially move along the longitudinal direction of the light emitting members 201. By switching the light-emitting pixel unit 203, that is, the liquid crystal element 202 in which the voltage is not applied, at a high speed, images can be displayed on the display screen 111 by using an afterimage effect. As a result, the display operation in the display device 100 is realized.

In the liquid crystal elements, transparent substrates, between which the liquid crystal material is sandwiched, are often formed by using a material having extremely low flexibility such as glass. Therefore, when a plurality of liquid crystal elements (not shown) continuous along the arrangement direction of the light emitting members 201 are provided along the longitudinal direction of the light emitting members 201, the liquid crystal elements are connected by using a flexible coupling member, and the light emitting members 201 are formed of a flexible material. Accordingly, the display screen 111 can be rolled around the center of axis substantially parallel to the longitudinal direction of the liquid crystal elements, and the rolled display screen 111 can be stored in the storage unit 120.

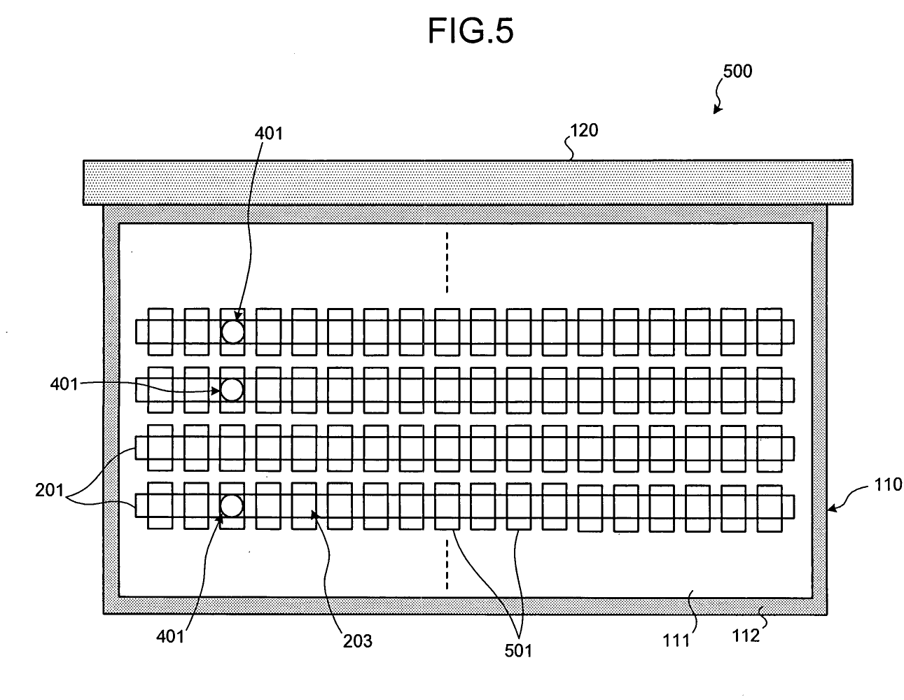

In the first embodiment, as shown in FIG. 4, while the display device 100, in which the liquid crystal elements 202 are respectively arranged for each of the light emitting members 201 along the longitudinal direction of the light emitting members 201, has been explained, the present invention is not limited thereto. FIG. 5 is a schematic of a display device having another configuration. As shown in FIG. 5, a display device 500 includes plural liquid crystal elements 501 having a size corresponding to one pixel unit 203 arranged along the longitudinal direction of the light emitting members 201.

According to the display device 100 in the first embodiment, since the image can be displayed by sequentially changing the pixel unit 203 that emits light in the light emitting members 201, the image can be displayed on a large screen without complicating the configuration. Furthermore, according to the display device 100, since the light emitting members 201 are connected so as to be rolled around the center of axis substantially parallel to the longitudinal direction of the light emitting members 201, the display device 100 can be made small while the light emitting members 201 are rolled up when the display device 100 is not used. As a result, the user can enjoy the image on a large screen, and can handle the display device easily, by rolling it into a small size when it is not used.

According to the display device 100 in the first embodiment, the light emitting members 201 in the state rolled around the center of axis substantially parallel to the longitudinal direction of the light emitting members 201 can be stored in the storage unit 120. Therefore, in the display device 100, the rolled display screen 111 is prevented from expanding unpreparedly. As a result, the user can handle the compact display device 100 easily.

Since the one end of the display screen 111 is supported by the support member provided in the storage unit 120, the display screen 111 can be rolled at a fixed position based on the support member. As a result, since the user can easily roll the light emitting members 201, and store the rolled light emitting members 201 in the storage unit 120, the user can easily handle the display device 100.

According to the display device 100 in the first embodiment, since the light emission controller that controls light emission of the pixel units 203 is provided in the storage unit 120, the display device 100 can be made small by integrating the respective units constituting the display device 100. As a result, the user can easily handle the display device 100.

According to the display device 100 in the first embodiment, since the light emitting members 201 can be formed by using well-known various materials such as polymer materials and glass by making the light emitting member 201 emit light by using the light source, various demands such as durability and the production cost of the device can be met. As a result, the user can enjoy the image on a large screen, and can handle the display device 100 easily, by rolling it into a small size when it is not used.

According to the display device 100 in the first embodiment, the accuracy of the light emission control in the pixel units 203 can be improved, by limiting the light emitted by the light emitting members 201 and the light to be transmitted through the pixel units 203 to the light polarized in a specific direction. As a result, the user can enjoy a high-definition image on a large screen, and can handle the display device 100 easily, by rolling it into a small size when it is not used.

According to the display device 100 in the first embodiment, by providing the light source for each of the light emitting members 201, each light source can be associated with each light emitting member 201, so as to have an independent configuration. Accordingly, by arranging optimum wiring for each light source, disconnection due to rolling of the display screen 111 can be prevented. As a result, the user can handle the display device 100 easily, at the time of rolling the display screen 111, without giving special attention.

According to the display device 100 in the first embodiment, since the light source is provided for each of the light emitting members 201 so as to emit light of a plurality of colors including red, blue, and green, a color image can be displayed on a large screen in the display device 100. In this case, when an image having the same resolution is to be displayed, the number of the light emitting members can be reduced compared to a case in which one light source is provided to each light emitting member 201. As a result, in the case of the same resolution, the display device can be made small, and in the case of the same size, the resolution can be made high.

According to the display device 100 in the first embodiment, since the light source is provided for each of the light emitting members 201 so as to emit red, blue, or green light, the user can enjoy a color image on a large screen, and can store the display device, by rolling the display device to a small size when it is not used. Furthermore, in this case, since one light source is provided for each light emitting member 201, the configuration can be simplified, and maintainability can be improved.

In the first embodiment, while an example in which a plurality of light sources are provided associated with each light emitting member 201 has been explained, the present invention is not limited thereto. For example, a plurality of light sources that emit light of red, blue, and green, respectively can be provided to each light emitting member 201. As a result, in the case of displaying an image with the same resolution, the number of the light emitting members 201 can be reduced compared to a case in which one light source is provided to each light emitting member 201.

When a light source that can change the light quantity to be radiated is used, by controlling the emission timing of light and the light quantity in the light source, to make any one pixel unit 203 emit light in the light emitting member 201 by the light emission controller, the luminous amount in each pixel unit 203 can be adjusted. As a result, the display device 100 that can display a gray-scale image on a large screen, and that can be made small when an image is not displayed, can be provided.

When a plurality of liquid crystal elements (not shown) continuous along the arrangement direction of the light emitting members 201 are provided along the longitudinal direction of the light emitting members 201, the light emission controller needs only to uniformly control the orientation of the liquid crystal molecules 204 in the liquid crystal elements 202 with respect to all of the light emitting members 201, and hence, the control by the light emission controller can be simplified.

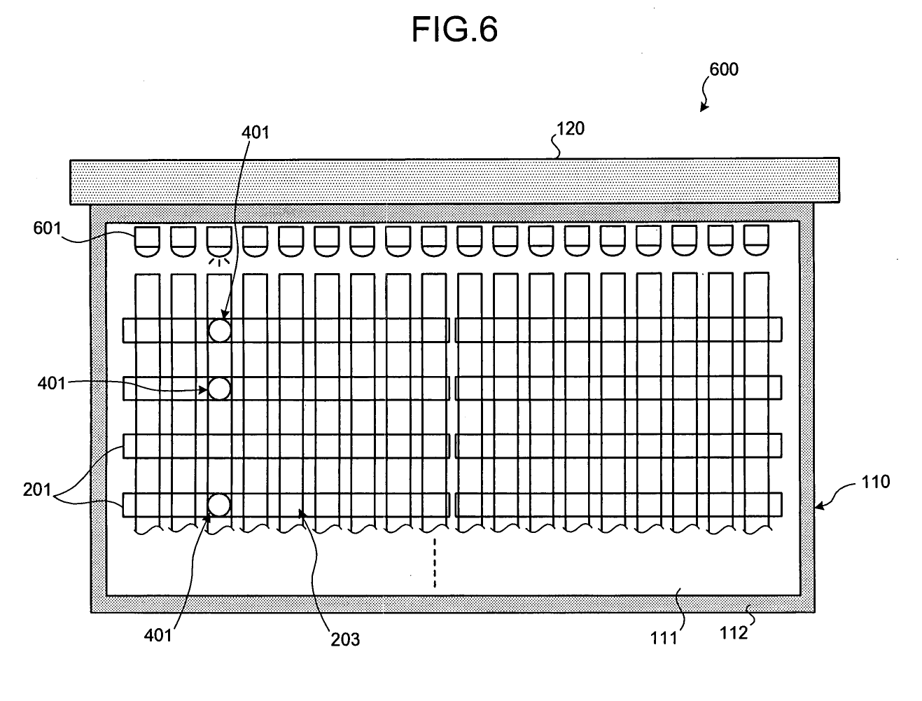

A display device according to a second embodiment of to the present invention has the basic configuration described above similarly to the first embodiment, and is applied to a display device that displays a still picture and a moving picture on a display screen. FIG. 6 is a schematic of the display device according to the second embodiment. Like reference numerals denote like parts as those explained above, and explanation thereof is omitted.

As shown in FIG. 6, the light emitting members 201 in a display device 600 in the second embodiment are provided with the longitudinal direction thereof being arranged substantially parallel to a direction orthogonal to a scanning direction on the display screen. The light emitting members 201 can be realized, for example, with flexible optical fibers. Reference numeral 601 in FIG. 6 denotes a light source.

In the second embodiment, while the light source 601 is provided on the upper part of the light emitting member 201, the present invention is not limited thereto. Although not shown, the light source 601 can be provided in, for example, the storage unit 120.

The liquid crystal elements 202 are provided with the longitudinal direction thereof being substantially parallel to the scanning direction on the display screen. In the second embodiment, the liquid crystal elements 202 having a general configuration using a glass material for the substrate can be used. In the display device 600 also, portions where the light emitting members 201 and the liquid crystal elements 202 cross each other become the pixel unit 203.

The light emission controller in the display device 600 makes the light emitting members 201 including the pixel units 401 that should emit light emit light based on the image data, and controls the voltage application/non-application timing in the electrode of the liquid crystal elements 202 including the pixel units 401 that should emit light.

According to the display device 600 in the second embodiment, the light emitting members 201, arranged along the display screen to emit light along the longitudinal direction can be rolled, respectively, around the center of axis not parallel to the longitudinal direction. Accordingly, for example, the light emitting members 201 are rolled around the center of axis substantially parallel to the longitudinal direction of the liquid crystal elements 202, and the rolled light emitting members 201 can be stored in the storage unit 120. Therefore, in the display device 600, the rolled display screen 111 is prevented from expanding unpreparedly. As a result, the user can easily handle the compact display device 600.

According to the display device 600 in the second embodiment, since the light emitting members 201 can be rolled around the center of axis parallel to the longitudinal direction of the liquid crystal elements 202, the liquid crystal elements 202 having a general configuration formed of a glass material having low flexibility can be used. Therefore, the display device 600 can maintain the accuracy in the orientation control of the liquid crystal molecules in the liquid crystal elements 202, and maintain excellent display performance. As a result, the user can enjoy a high-quality image on a large screen, and can handle the display device easily by rolling it into a small size when it is not used.

According to the display device 600 in the second embodiment, by providing the light sources 601 in the storage unit 120, the display area of the display screen 111 can be enlarged, and the storage unit 120 can protect the light sources 601 from external impact and the like. Accordingly, the display device 600 can display a larger image, and the resistance to an impact applied at the time of rolling the display device 600 when it is not used, can be improved. Consequently, users can enjoy images on a larger screen, and can handle the display device easily by rolling it into a small size when it is not used.

In the first and the second embodiments, while the display devices 100 and 600 in which the storage unit 120 is provided on an upper side of the display screen 111 when the image is displayed have been explained, the present invention is not limited thereto. The storage unit 120 can be provided, for example, on a side of the display screen 111 when the image is displayed.

In the first and the second embodiments, while the display screen 111 having a long shape in a horizontal direction when the image is displayed has been explained, the present invention is not limited thereto. For example, the display device can have a display screen having a long shape in a vertical direction, like a scroll picture, when the image is displayed. Furthermore, the shape of the display screen is not limited to a rectangular shape, and can be, for example, triangular with the support member being a base.

According to an example of the first embodiment, the invention is applied to a display device that displays a TV program, recorded contents, images of digital photographs, or the like.

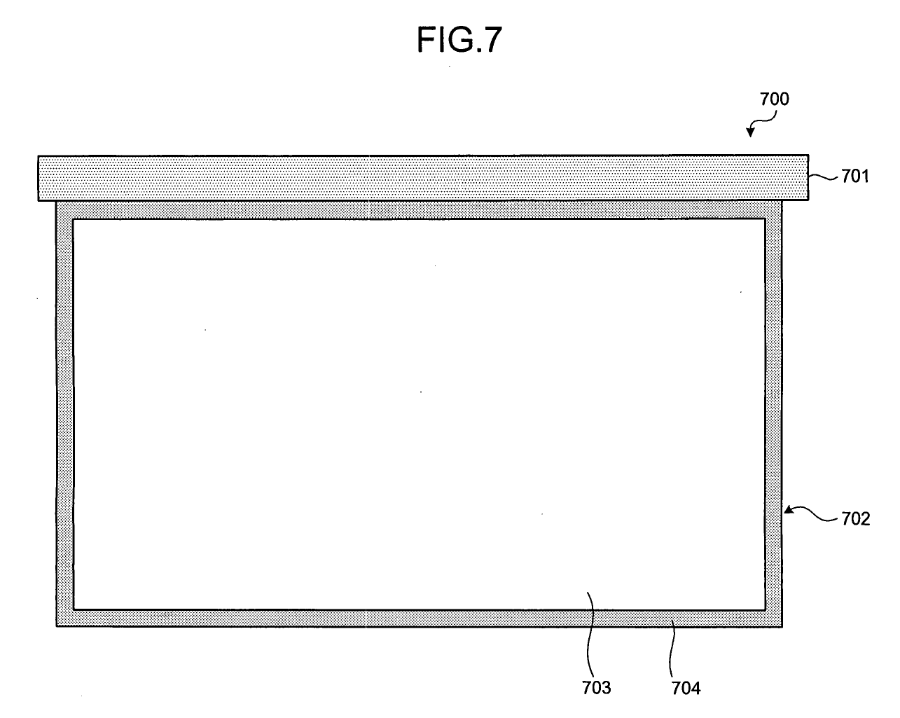

FIG. 7 is a plan view of the display device according to the example. As shown in FIG. 7, a display device 700 includes a storage unit 701, and a display unit 702. The storage unit 701 has a box shape, and has a storage space therein. An opening (not shown) is provided on one side of the storage unit 701.

The display unit 702 has a sheet-like shape or a flat shape. One side of the display unit 702 is inserted into the storage unit 701 via the opening. In the display unit 702, the one side inserted into the storage unit 701 is supported by a support mechanism (not shown) provided in the storage unit 701. The support mechanism has a shaft (not shown), to which the one side of the display unit 702 is fixed. The display unit 702 includes a display screen 703 and a display frame 704. Images are displayed on the display screen 703, and the display frame 704 is provided outside of the display screen 703. The display frame 704 can be provided so as to cover the back side of the display screen 703. The display frame 704 is formed of a flexible material.

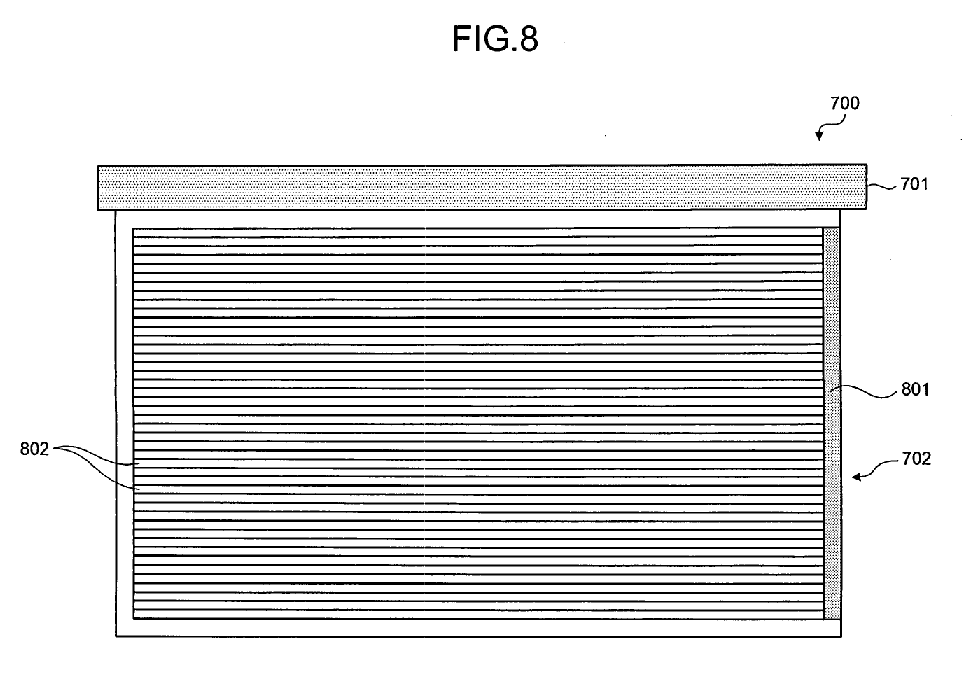

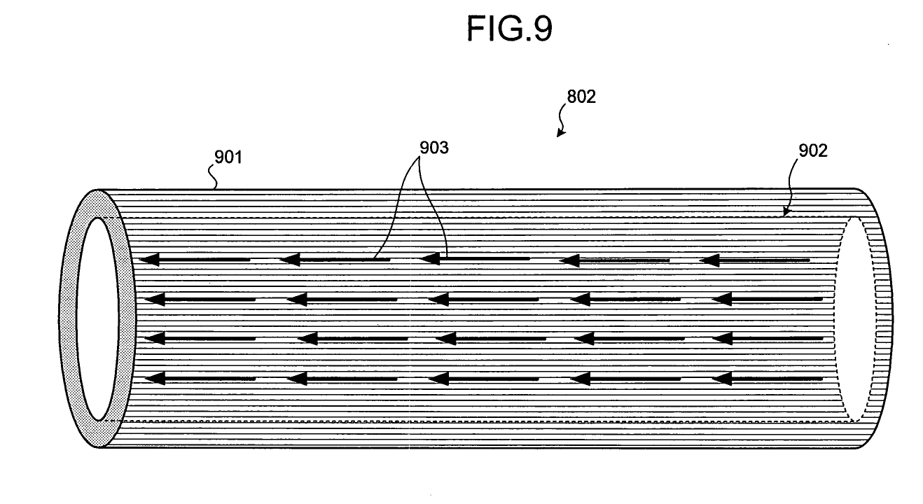

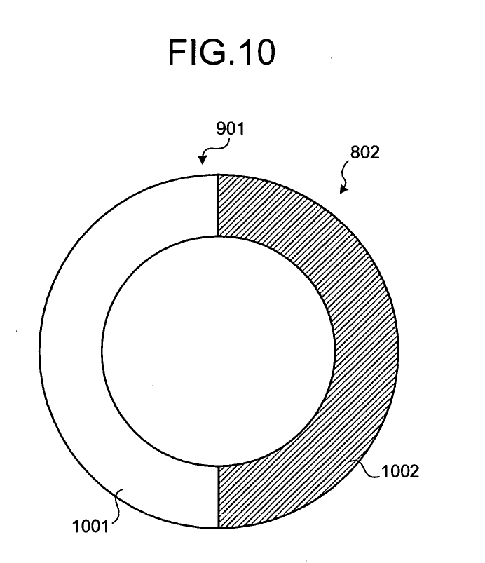

FIG. 8 is a schematic of the display screen 703. The display screen 703 includes a light source 801, a plurality of light emitting tubes 802 (see FIG. 9 or 10), a liquid crystal element (not shown), and an electrode (not shown).

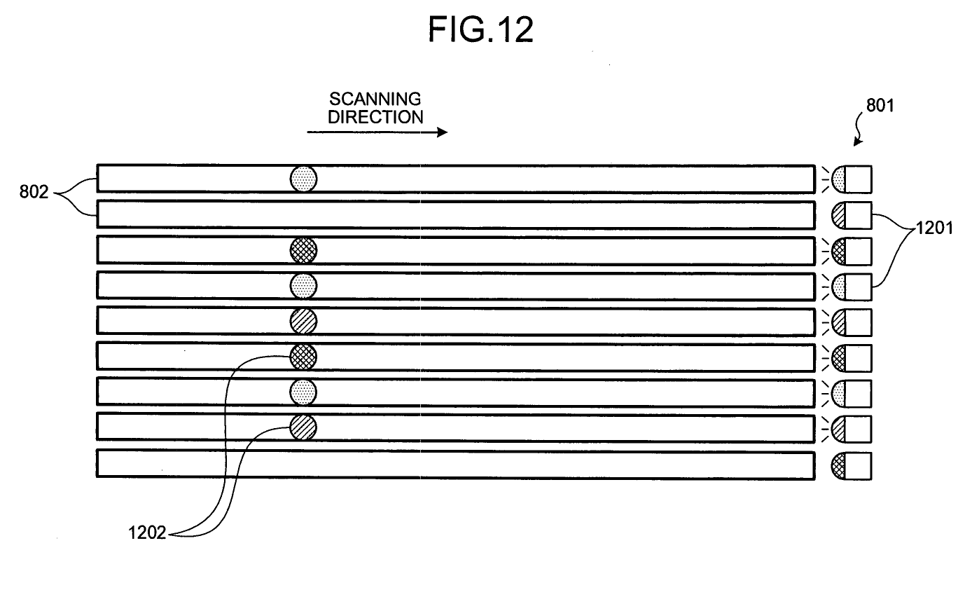

The light source 801 includes a plurality of LED light sources (see FIG. 12) respectively associated with each light emitting tube 802. Three types of LED light sources (see FIG. 12) that emit red, blue, or green light are respectively provided in a plurality of numbers in the light source 801. In the light source 801, the LED light sources that emit light of red, blue, or green are arranged in a predetermined order.

The light emitting tubes 802 are arranged in parallel with each other, respectively, along the display screen. Each light emitting tube 802 is arranged with the longitudinal direction thereof being substantially parallel to the scanning direction. FIG. 9 is a perspective view of the light emitting tube 802. The light emitting tube 802 includes a tube 901 formed of a material having an optical transparency, and a liquid crystal material 902 provided on an outer circumference of the tube 901.

The material forming the tube 901 and the liquid crystal material 902 is not particularly limited. The orientation of liquid crystal molecules 903 in the liquid crystal material 902 is controlled so that the light polarized in a specific direction, of the light emitted from the respective LED light sources in the LED light source 801, is transmitted to outside of the tube 901.

A polarizing plate that transmits the light polarized in the specific direction can be provided, instead of the liquid crystal material, on the outer circumference of the tube 901. The polarizing plate can be provided by affixing a transparent sheet, on which a predetermined polarization pattern is printed, to the outer circumference of the tube 901, or by directly printing the predetermined polarization pattern on the outer circumference of the tube 901.

The configuration of the light emitting tube 802 is not limited to the one shown in FIG. 9, and can be a configuration, for example, as shown in FIG. 10. FIG. 10 is a cross section of another light emitting tube 802. As shown in FIG. 10, the other light emitting tube 802 includes the tube 901 formed of two materials.

As shown in FIG. 10, the tube 901 includes two members 1001 and 1002 formed of different materials. One of the members 1001 is formed of a material having an optical transparency, and is positioned on the display screen side. The other member 1002 is formed of a metal material, and is positioned on the side away from the display screen. The other member 1002 reflects light emitted toward the side away from the display screen, of light emitted by the light emitting tube 802, toward the display screen.

The metal material is not limited to the one forming a part of the tube 901, like the other member 1002, and can be provided in a part of the tube 901 formed of a material having an optical transparency. Specifically, a film formed of the metal material is formed in a portion away from the display screen. This film can be provided on an inner circumference of the tube 901, or on the outer circumference thereof. In the example, while the tube 901 having a cylindrical shape is used, the tube 901 can have various shapes, for example, a polygonal shape such as a triangle or a square, or an elliptical shape in cross section, within a range not causing any problem in the required light quantity and rolling up of the display screen 703.

Although not shown, plural liquid crystal elements are arranged for each light emitting tube 802 along the longitudinal direction of the light emitting tubes 802, as explained in the first and the second embodiments. In a region where light emitting members 602 and the liquid crystal elements cross each other, a pixel unit (not shown) is formed. The pixel units are present as much as the number of arrangement of the liquid crystal elements. In the display device 700, the number of the pixel units corresponds to the number of pixels. Although not shown, similarly to the liquid crystal elements, a pair of electrodes is provided for each liquid crystal element. That is, the display device 700 includes the same number of electrode pairs as the number of the liquid crystal elements.

The display screen 703 also includes a protection sheet, which covers all the light emitting tubes 802 from outside. The protection sheet is formed of a material having an optical transparency in a level not damaging the visibility of an image displayed on the display screen 703. The protection sheet is formed of a material having flexibility in the same level as that of the material forming the display frame 704. The light emitting tubes 802 are fixed to the protection sheet, with a predetermined gap therebetween, by a fixing member (not shown). A protection sheet having a function of improving the optical characteristics in the display device 700, such as a reflection preventing film and a color filter can be used.

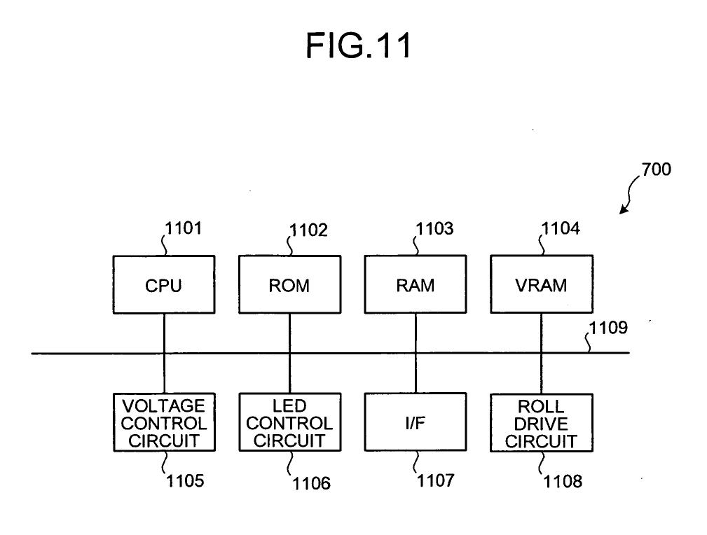

FIG. 11 is a block diagram of the display device 700. The display device 700 includes a central processing unit (CPU) 1101, a read-only memory (ROM) 1102, a random-access memory (RAM) 1103, a video RAM (VRAM) 1104, a voltage control circuit 1105, an LED control circuit 1106, an interface (I/F) 1107, and a roll drive circuit 1108. The respective units 1101 to 1108 in the display device 700 are connected to each other by a bus 1109, and provided in the storage unit 701.

The CPU 1101 controls the entire display device 700. The ROM 1102 records various control programs such as a boot program. The RAM 1103 is used as a work area of the CPU 1101. That is, the CPU 1101 executes various programs recorded in the ROM 1102, while using the RAM 1103 as the work area, thereby controlling the entire display device 700.

The VRAM 1104 temporarily records image data that can be immediately displayed on the display screen 703. The voltage control circuit 1105 controls the voltage application/non-application timing by the electrode described later. The voltage control circuit 1105 changes the voltage to the non-applied state with respect to the electrodes positioned at the same position along the direction of scanning lines, at the same timing. The LED control circuit 1106 controls the light emitting operation in the light source 801. That is, the LED control circuit 1106 controls the light emitting operation of the light emitting tubes 802 so that the light is incident corresponding to the respective timing.

The I/F 1107 is connected to external devices such as a personal computer, wirelessly or via a communication cable, and functions as an interface between the external devices and the CPU 1101. Since the I/F 1107 is connected to the external devices, the I/F 1107 can receive image data transmitted from the personal computer or the like. The I/F 1107 also has a function of detecting an operation command from a user.

The roll drive circuit 1108 drives a motor that rotates the shaft included in the support mechanism provided inside of the storage unit 701, according to an operation by a user or a program. The roll drive circuit 1108 rotates the shaft in a direction of rolling up the display screen 703, for example, when an instruction to turn off the power or to store the display screen 703 is received from the user. Since the end of the display screen 703 is fixed to the shaft, the display screen 703 is rolled around the center of axis, with the rotation of the shaft, and stored in the storage unit 701.

When an instruction to turn on the power or to display an image is received from the user, the roll drive circuit 1108 rotates the shaft in a direction of rolling out the display screen 703. The display screen 703 is rolled out, while rotating around the center of axis, with the rotation of the shaft, and is rolled out to a position where an image can be displayed.

FIG. 12 is a schematic for illustrating a display operation by the display device 700. FIG. 12 depicts a part of the light emitting tubes 802 in the display screen 703. Reference numeral 1201 denotes the LED light source provided for each light emitting tube 802.

With reference to FIG. 12, at the time of displaying an image on the display screen 703, the relevant LED light source 1201 is lit based on the image data. At the same time, application of the voltage is stopped in the relevant electrode, based on the same image data. At this time, the CPU 1101 controls so that the voltage is not applied in any one electrode, for each light emitting tube 802. As a result, any one pixel unit 1202 emits light for each light emitting tube 802.

Such a light emitting operation is sequentially performed along the scanning direction indicated by an arrow in FIG. 12. Accordingly, the pixel unit 1202 that emits light in the display screen 703 is sequentially shifted along the scanning direction. The display device 700 shifts the pixel unit 1202 that emits light at a high speed, to display an image on the display screen using the afterimage effect.

According to the example, switching of the electrode, to which the voltage is not applied, by the voltage control circuit 1105 based on the image data is performed at a high speed faster than a predetermined speed. As a result, an image having a resolution as high as the number of pixels calculated by multiplying the number of light emitting tubes 802 by the number of arrangement of the liquid crystal elements for each light emitting tube 802 can be displayed on the display screen 703. Hence, the display device 700 can display an image on a large screen without complicating the configuration, compared to a display device provided with the light emitting devices for the same resolution as that of the display device 700.

According to the example, since the display unit 702 can be rolled up around the center of axis substantially parallel to the longitudinal direction of the light emitting tubes 802, the size of the display device 700 can be increased or reduced without deforming the light emitting tubes 802. Therefore, the user can enjoy an image on a large screen and easily handle the compact display device 700 when it is not used.

According to the example, the display unit 702 rolled around the center of axis substantially parallel to the longitudinal direction of the light emitting tubes 802 can be stored in the storage unit 120. Therefore, in the display device 700, the rolled display unit 702 is prevented from expanding unpreparedly. As a result, the user can easily handle the compact display device 700.

Since the one side of the display unit 702 is supported by the support member provided in the storage unit 701, the display screen 111 can be rolled at a fixed position based on the support member. As a result, since the user can easily roll the display unit 702, and store the rolled display unit 702 in the storage unit 701, the user can easily handle the display device 700.

According to the example, since the respective units 1101 to 1107 that control the display operation in the display device 700 are provided in the storage unit 701, the respective units constituting the display device 700 can be integrated, thereby reducing the size of the display device 700. As a result, the user can easily handle the display device 700.

According to the example, since the light emitting tubes 802 emit light by using the LED light source, for example, alternatives for the material forming the light emitting tubes 802 are increased, and the light emitting tubes 802 can be formed by using various known materials such as polymer materials and glass. As a result, the user can obtain the display device 700, which satisfies various requirements such as durability required for the display device 700 and the production cost of the device.

According to the example, the accuracy of light emission control in the pixel unit 1202 can be improved by limiting the light emitted by the light emitting tubes 802 and the light transmitted in the pixel unit 1202 to the light polarized in the specific direction. As a result, the user can enjoy a high-definition image on a large screen, and can handle the display device 700 easily by rolling it into a small size when it is not used.

According to the example, since the LED light source 1201 is provided for each light emitting tube 802, each LED light source 1201 can be associated with each light emitting tube 802, to have an independent configuration respectively. Accordingly, by laying out optimum wiring for each LED light source 1201, disconnection due to rolling of the display unit 702 can be prevented. As a result, the user can easily handle the display device 700 without paying special attention at the time of rolling the display unit 702.

According to the example, since the LED light source 1201 is provided for each light emitting tube 802, to emit red, blue, or green light, the user can enjoy a color image on a large screen, and can store the display device by rolling it into a small size when it is not used. Since the LED light source 1201 is provided for each light emitting tube 802, the configuration is simplified, thereby improving the maintainability.

In the example, the light quantity emitted from the LED light source 1201 can be variable. Specifically, the electric energy supplied to respective LED light sources 1201 is adjusted based on the image data by the LED control circuit 1106. Accordingly, light emitting luminance of the respective pixel units 1202 can be adjusted. As a result, the user can enjoy a gray-scale image on a large screen, and can easily handle the display device 700 by rolling it into a small size when it is not used.

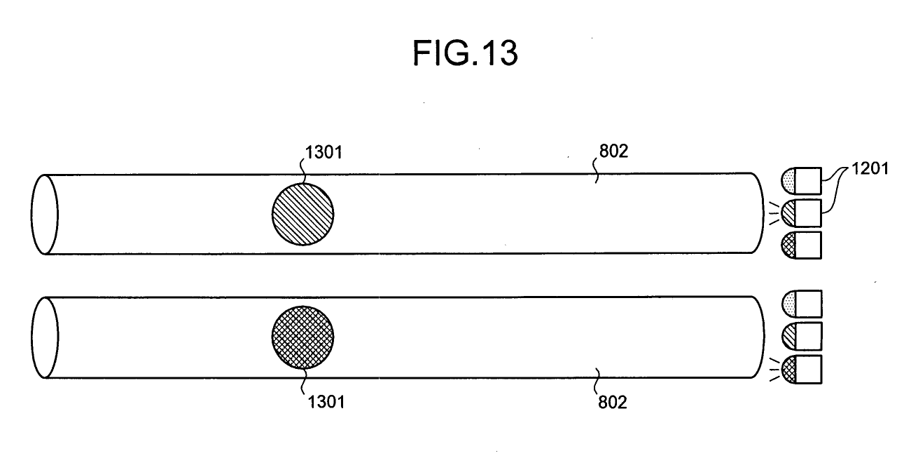

In the example, while plural LED light sources 1201 are provided respectively associated with each light emitting tube 802, the present invention is not limited thereto. FIG. 13 is a schematic of a display device according to another example. As shown in FIG. 13, in the display device, plural LED light sources 1201 that emit red, blue, or green light, respectively, are provided for each light emitting tube 802. Reference numeral 1301 in FIG. 13 denotes the pixel unit that emits light in the light emitting tube 802. The pixel unit 1301 emits light in a color corresponding to the lighted LED light source 1201.

With the above configuration, when an image having the same resolution as that in the display device 700 is to be displayed, the number of light emitting tubes 802 can be reduced to ⅓ of the number thereof in the display device 700. As a result, the configuration can be simplified. Furthermore, if the display device is formed in the same size as that of the display device 700, the resolution of the displayed image can be made three times as high as that of the display device 700, thereby improving the image quality.

In the example, while the display device 700 in which the light emitting tubes 802 are arranged, with the longitudinal direction thereof being parallel to the scanning direction, has been explained, the present invention is not limited thereto. As explained in the first embodiment, the longitudinal direction of the light emitting tubes 802 can be perpendicular to the scanning direction, and a plurality of long liquid crystal elements can be provided along the longitudinal direction of the light emitting tubes 802. As a result, liquid crystal elements formed of a general material can be used.

In the example, with reference to FIGS. 12 and 13, while the display device 700 in which all light sources are provided at one end of the light emitting tubes 802 in the longitudinal direction has been explained, the present invention is not limited thereto. Although not shown, the light sources can be provided alternately at one end and at the other end of the light emitting tubes 802 in the longitudinal direction. For example, when a certain light source is provided at one end of the corresponding light emitting tube 802 in the longitudinal direction, the light source corresponding to the adjacent light emitting tube 802 can be provided at the other end of the light emitting tube 802 in the longitudinal direction.

Furthermore, it is not limited to the example in which the light source is provided alternately for each light emitting tube 802. For example, the light source can be provided alternately for each of a plurality of light emitting tubes 802, if it is the same number for each of two light emitting tubes 802. In any case, as long as the weight applied to the entire display device 700 in the perpendicular direction is evenly balanced, the pattern of the arrangement of the light sources is not limited thereto.

As explained above, according to the display device 700, images can be displayed on a large screen without complicating the configuration. Accordingly, its users can enjoy the images on a large screen, and can handle the display device easily, by rolling it into a small size when it is not used.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2005-372646 filed in Japan on Dec. 26, 2005.

What is claimed is:

1. A display device that displays an image, comprising:
a display screen including a plurality of light emitting members configured to emit light along a longitudinal direction thereof and arranged along the display screen, wherein
the light emitting members are coupled to each other so that the light emitting members are rolled around center of axis substantially parallel to the longitudinal direction.

2. The display device according to claim 1, further comprising:
a storage unit configured to store rolled light emitting members; and
a support member arranged in the storage unit, and configured to support one end of the display screen.

3. The display device according to claim 2, further comprising a light emission controller configured to control light emission of the light emitting members, and arranged in the storage unit, wherein
each of the light emitting members includes a plurality of pixel units arranged along the longitudinal direction, and
the light emission controller is configured to control the light emission by selecting one of the pixels to emit light for each of the light emitting members.

4. The display device according to claim 3, further comprising a light source configured to input light into the light emitting members, wherein
the light emitting members are configured to emit light by propagating the light in the longitudinal direction, and
the light emission controller is configured to make the one of the pixel units emit light by changing a direction of propagated light toward a display surface on which the image is to be displayed.

5. The display device according to claim 4, wherein
the light emitting members are configured to emit light that is polarized in a specific direction; and
the light emission controller is configured to make the one of the pixel units emit light by transmitting the polarized light toward the display surface.

6. The display device according to claim 4, wherein the light source is provided for each of the light emitting members.

7. The display device according to claim 6, wherein the light source is configured to emit light having a plurality of colors including red, blue, and green.

8. The display device according to claim 6, wherein the light source is configured to emit light having a color of any one of red, blue, and green for each light emitting member.

9. A display device that displays an image, comprising a display screen including a plurality of light emitting members configured to emit light along a longitudinal direction thereof, and arranged along the display screen, wherein
the light emitting members are arranged so that the light emitting members are rolled around center of axis not parallel to the longitudinal direction.

10. The display device according to claim 9, further comprising:
a storage unit configured to store rolled light emitting members; and
a support member arranged in the storage unit, and configured to support one end of the display screen.

11. The display device according to claim 10, further comprising a light emission controller configured to control light emission of the light emitting members, and arranged in the storage unit, wherein
each of the light emitting members includes a plurality of pixel units arranged along the longitudinal direction, and
the light emission controller is configured to control the light emission by selecting one of the pixels to emit light for each of the light emitting members.

12. The display device according to claim 11, further comprising a light source configured to input light into the light emitting members, wherein
the light emitting members are configured to emit light by propagating the light in the longitudinal direction, and
the light emission controller is configured to make the one of the pixel units emit light by changing a direction of propagated light toward a display surface on which the image is to be displayed.

13. The display device according to claim 12, wherein
the light emitting members are configured to emit light polarized in a specific direction; and
the light emission controller is configured to make the one of the pixel units emit light by transmitting polarized light toward the display surface.

14. The display device according to claim 12, wherein the light source is provided for each of the light emitting members.

15. The display device according to claim 14, wherein the light source is configured to emit light having a plurality of colors including red, blue, and green.

16. The display device according to claim 14, wherein the light source is configured to emit light having a color of any one of red, blue, and green for each light emitting member.

17. A display device that displays an image, comprising:
a display screen; and
a control unit configured to controls display of the image on the display screen; wherein,
the display screen includes
a plurality of optical fibers each of which has a light emitting device on one of edges thereof, the optical fibers arranged on a flexible sheet in a first direction, and
a plurality of optical shutters configured to intercept light emitted from the optical fibers, and the optical shutters arranged on the optical fibers in a second direction, wherein
the control unit controls the light emitting device and the optical shutter based on image data.

18. The display device according to claim 17, wherein a first side of the optical fiber is covered with a polarization layer and a second side of the optical fiber is covered with a reflection layer.

19. The display device according to claim 17, further comprising a storage unit configured to store the display screen that is folded or rolled up.

20. The display device according to claim 17, wherein the first direction and the second direction are perpendicular to each other.
